(19) United States
(12) Patent Application Publication
(10) Pub. No.: US 2014/0170979 A1
(43) Pub. Date: Jun. 19, 2014

(54) CONTEXTUAL POWER SAVING IN BLUETOOTH AUDIO

(71) Applicant: QUALCOMM INCORPORATED, San Diego, CA (US)

(72) Inventor: Anil Ranjan Roy SAMANTA SINGHAR, San Diego, CA (US)

(73) Assignee: QUALCOMM Incorporated, San Diego, CA (US)

(21) Appl. No.: 13/717,628

(22) Filed: Dec. 17, 2012

(51) Int. Cl. H04W 52/02

(52) U.S. Cl. CPC H04W 52/0251
USPC 455/41.2

(57) ABSTRACT

A method of reducing power consumption in a wireless headset paired to a mobile device is disclosed. The mobile device receives a first audio signal via a microphone on the mobile device, and determines an audio quality of the first audio signal. In response thereto, the mobile device may selectively deactivate a microphone on the headset to reduce its power consumption. For some embodiments, the audio quality may be determined, in part, upon a distance between the mobile device and the headset. For other embodiments, the audio quality may be determined, in part, upon a comparison between audio signals received by the mobile device microphone and the headset microphone.

### TECHNICAL FIELD

The present embodiments relate generally to wireless devices, and specifically to reducing power consumption in wireless devices.

### BACKGROUND OF RELATED ART

Wireless Personal Area Network (PAN) communications such as Bluetooth communications allow for short range wireless connections between two or more paired wireless devices (e.g., that have established a wireless communication channel or link). Many mobile devices such as cellular phones utilize wireless PAN communications to exchange data such as audio signals with wireless headsets. Because wireless headsets are typically powered by batteries that may be inconvenient to charge during use, it is desirable to minimize power consumption of such wireless headsets.

### BRIEF DESCRIPTION OF THE DRAWINGS

The present embodiments are illustrated by way of example and are not intended to be limited by the figures of the accompanying drawings, where:

FIG. 1 shows a wireless system within which the present embodiments may be implemented.

FIG. 2 shows a block diagram of a mobile device in accordance with some embodiments.

FIG. 3 is an illustrative flow chart depicting an exemplary operation for reducing power consumption in accordance with some embodiments.

FIGS. 4A-4B depict exemplary operations for determining a quality level of audio signals in accordance with some embodiments.

FIG. 5 depicts relative proximities of the mobile device, headset, and user of FIG. 1.

FIG. 6 is an illustrative flow chart depicting an exemplary operation for determining proximity of the mobile device to the headset.

FIG. 7 is an illustrative flow chart depicting an exemplary operation for determining a privacy level of the user of FIG. 1.

FIG. 8 depicts background noise components associated with audio signals received by the mobile device and/or wireless headset of FIG. 1.

FIG. 9 is an illustrative flow chart depicting an exemplary noise cancellation operation in accordance with some embodiments.

FIG. 10 depicts one embodiment of the noise cancellation operation of FIG. 9.

FIG. 11 is an illustrative flow chart depicting an exemplary operation for reducing silent intervals in accordance with some embodiments.

FIG. 12 depicts an exemplary embodiment for transmitting PLC frames during silent intervals.

### DETAILED DESCRIPTION

The present embodiments are described below in the context of reducing power consumption in Bluetooth-enabled devices for simplicity only. It is to be understood that the present embodiments are equally applicable for reducing power consumption in devices that communicate with each other using signals of other various wireless standards or protocols used for Personal Area Networks (PANs). As used herein, the term “wireless communication medium” can include communications governed by the IEEE 802.11 standards, Bluetooth, HiperLAN (a set of wireless standards, comparable to the IEEE 802.11 standards, used primarily in Europe), and other technologies used in wireless communications. Further, the term “mobile device” refers to a wireless communication device capable of wirelessly exchanging data signals with another device, and the term “wireless headset” refers to a short-range wireless device capable of exchanging data signals with the mobile device (e.g., using Bluetooth communication protocols). The terms “wireless headset” and “headset” may be used herein interchangeably.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components.

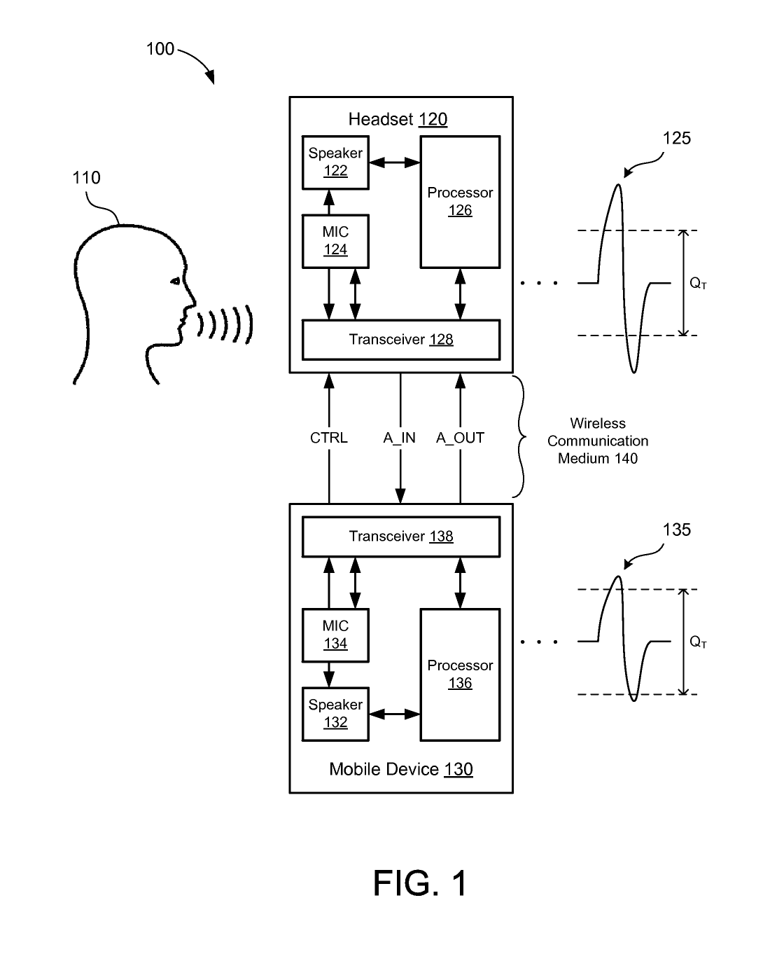

FIG. 1 shows a wireless system 100 within which the present embodiments may be implemented. System 100 is shown to include a user 110, a wireless headset 120, a mobile device 130, and a wireless communication medium 140. Wireless headset 120 may be connected to (e.g., “paired” with) mobile device 130 via wireless communication medium 140. Communication medium 140 may facilitate the exchange of signals transmitted according to any suitable wireless communication standards or protocols including, for example, Bluetooth communications, Wi-Fi communications (e.g., governed by the IEEE 802.11 family of standards), and/or other communications using short range and/or radio frequency (RF) signals.

Headset 120, which may be any suitable wireless headset (e.g., in-ear headsets, headphones, or other suitable paired device), includes a built-in speaker 122, a built-in microphone (MIC) 124, a processor 126, and a transceiver 128. Processor 126 is coupled to and may control the operation of speaker 122, microphone 124, and/or transceiver 128. Headset 120 facilitates the exchange of data signals (e.g., audio signals) between user 110 and mobile device 130. More specifically, headset speaker 122 outputs audio signals received from mobile device 130 to user 110, and headset microphone 124 detects and receives, as input, audio signals 125 generated by user 110 (e.g., voice data) for transmission to mobile device 130 (e.g., using transceiver 128). Transceiver 128 facilitates the exchange of audio signals A_IN and A_OUT between headset 120 and mobile device 130. Thus, for some embodiments, headset 120 receives audio signals 125 generated (e.g., spoken) by user 110 and transmits audio signals 125 as audio signals A_IN to mobile device 130, and headset 120 receives audio signals A_OUT (e.g., corresponding to voice data of another user) from mobile device 130 and outputs audio signals to user 110 via its speaker 122.

Mobile device 130, which may be any suitable mobile communication device (e.g., cellular phone, cordless phone, tablet computer, laptop, or other portable communication device), includes a built-in speaker 132, a built-in microphone 134, a processor 136, and a transceiver 138. Processor 136 is coupled to and may control the operation of speaker 132, microphone 134, and/or transceiver 138. More specifically, device speaker 132 outputs audio signals received by mobile device 130 from another user to user 110, and device microphone 134 detects and receives, as input, audio signals 135 generated (e.g., spoken) by user 110. Transceiver 138 facilitates the exchange of audio signals A_IN and A_OUT between headset 120 and mobile device 130. In addition, transceiver 138 may also facilitate the exchange of audio signals and/or other data signals between mobile device 130 and another user of another mobile device via a suitable cellular network (not shown for simplicity). Thus, for the exemplary embodiment of FIG. 1, transceiver 138 may be used to facilitate wireless PAN (e.g., Bluetooth) data exchanges with headset 120 and to facilitate cellular data exchanges with other mobile devices. For other embodiments, separate transceivers may be used to facilitate wireless PAN and cellular data exchanges.

During operation of system 100, mobile device 130 receives audio output (A_OUT) signals transmitted from another mobile device (via the cellular network), and then re-transmits the A_OUT signals to wireless headset 120 using transceiver 138. Headset 120 receives the A_OUT signals using its transceiver 128, and then outputs the received A_OUT signals to user 110 via its speaker 122. Headset 120 receives audio signals 125 from user 110 via its microphone 124, and transmits the audio signals 125 as audio signals A_IN to mobile device 130 using its transceiver 128. Mobile device 130 receives the A_IN signals transmitted from headset 120, and then transmits the A_IN signals to another mobile phone using its transceiver 138 (via the cellular network). Mobile device 130 may also receive audio signals 135 from user 110 using its built-in microphone 134, and then transmits the audio signals 135 to another mobile phone using its transceiver 138 (via the cellular network).

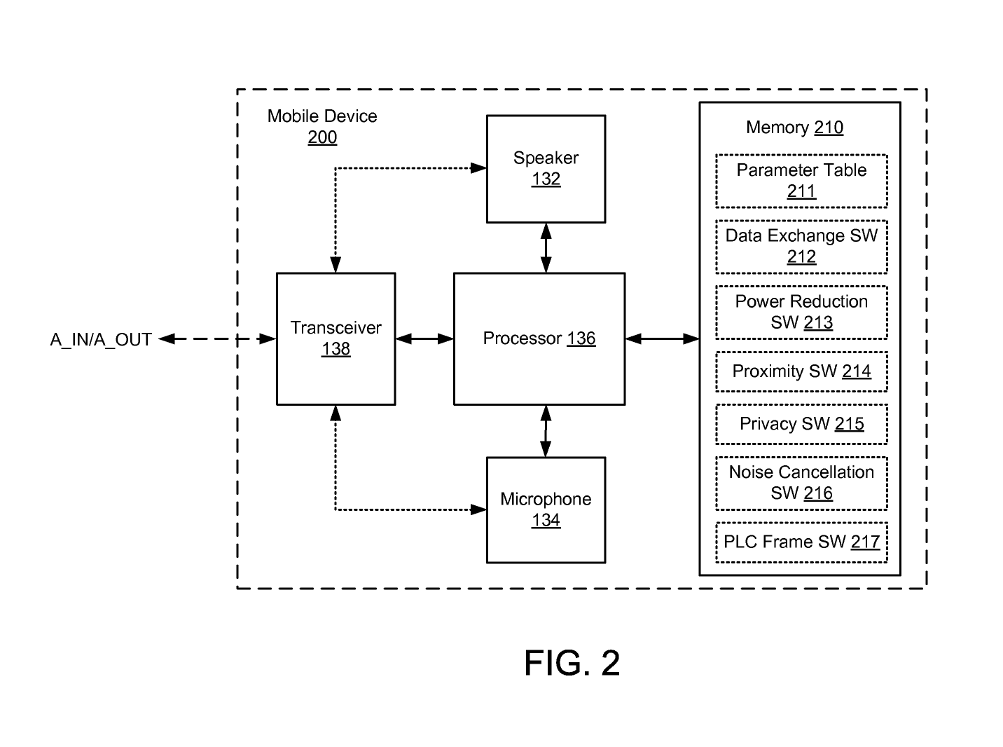

FIG. 2 shows a mobile device 200 that is one embodiment of mobile device 130 of FIG. 1. Mobile device 200 is shown to include speaker 132, microphone 134, processor 136, and transceiver 138 of FIG. 1, as well as a memory 210. As mentioned above, transceiver 138 may be used to exchange signals with headset 120 (e.g., using Bluetooth and/or Wi-Fi communications), to exchange signals with another mobile device (e.g., using cellular communications such as GSM, CDMA, LTE, and so on), and/or to exchange signals with other devices such as access points using Wi-Fi communications.

Memory 210 may include a parameters table 211 that stores a number of contextual power saving parameters including, for example, one or more audio quality threshold values, one or more audio proximity threshold values, one or more noise threshold values, and/or one or more silent interval threshold values.

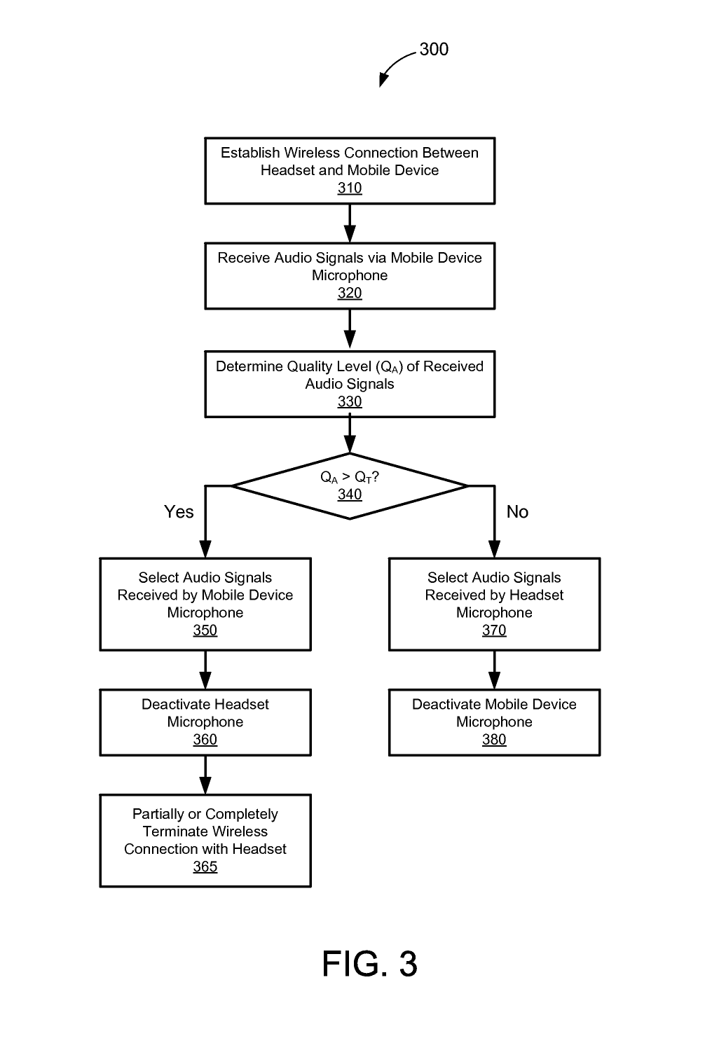

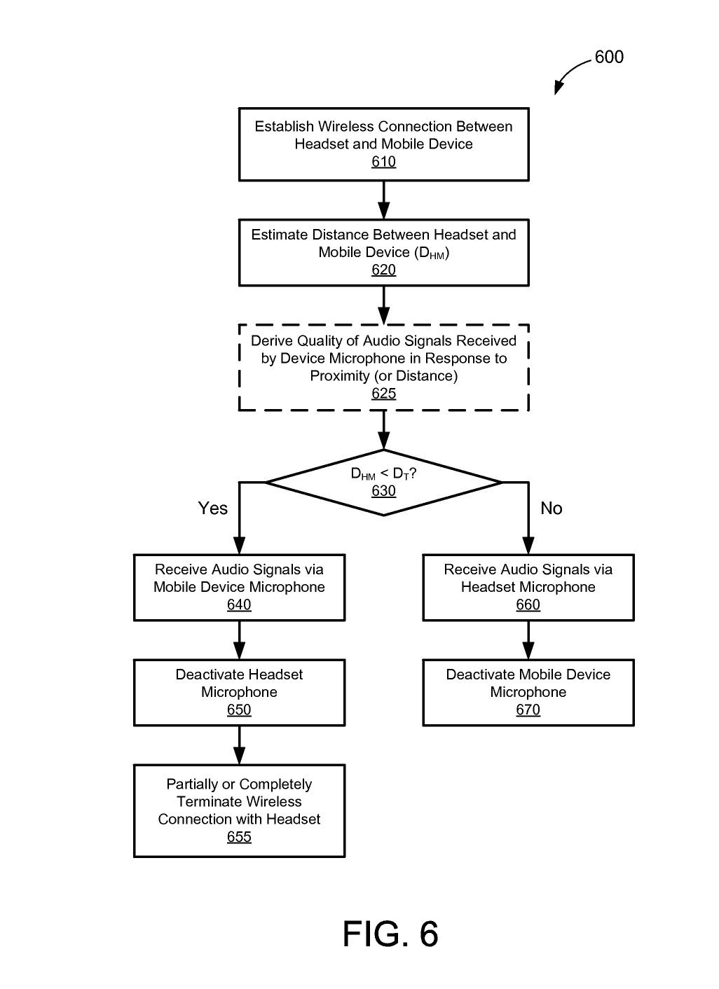

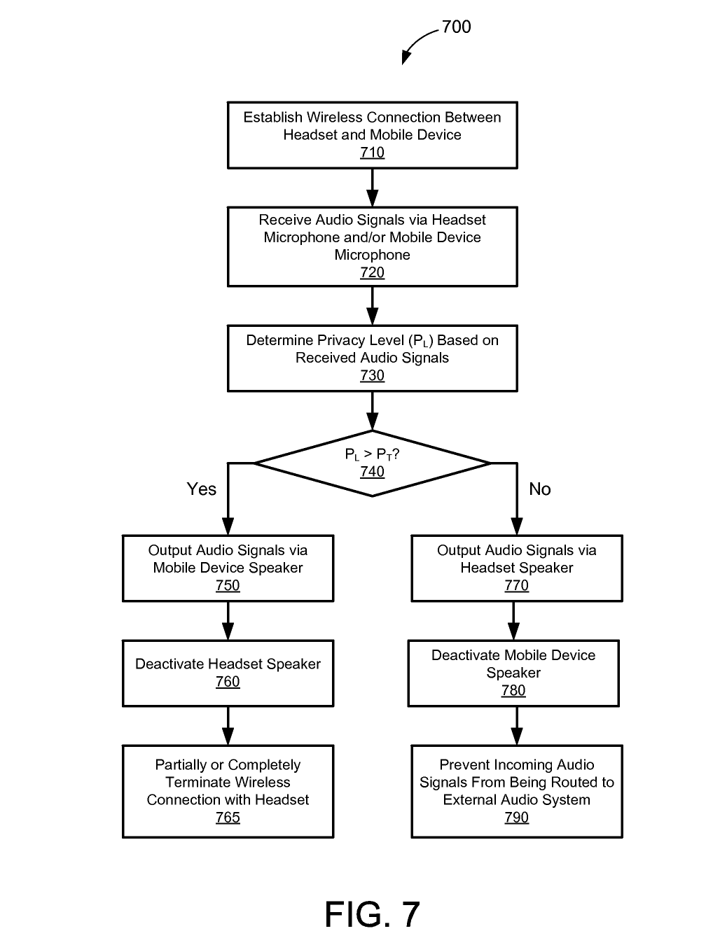

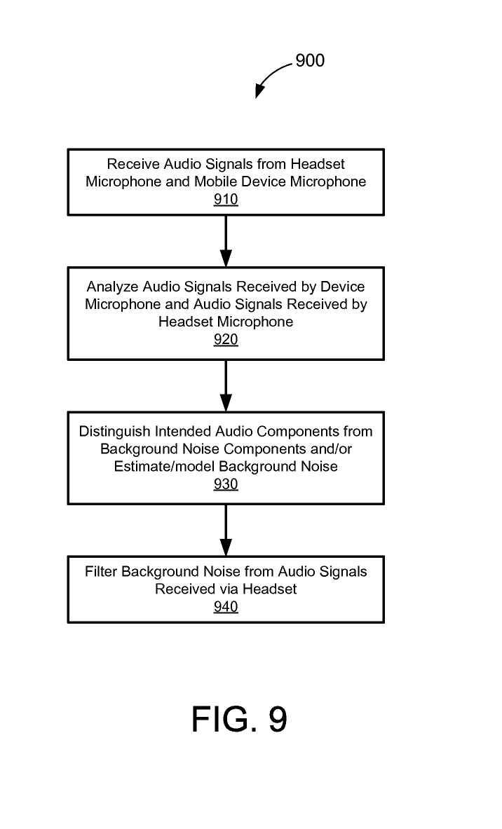

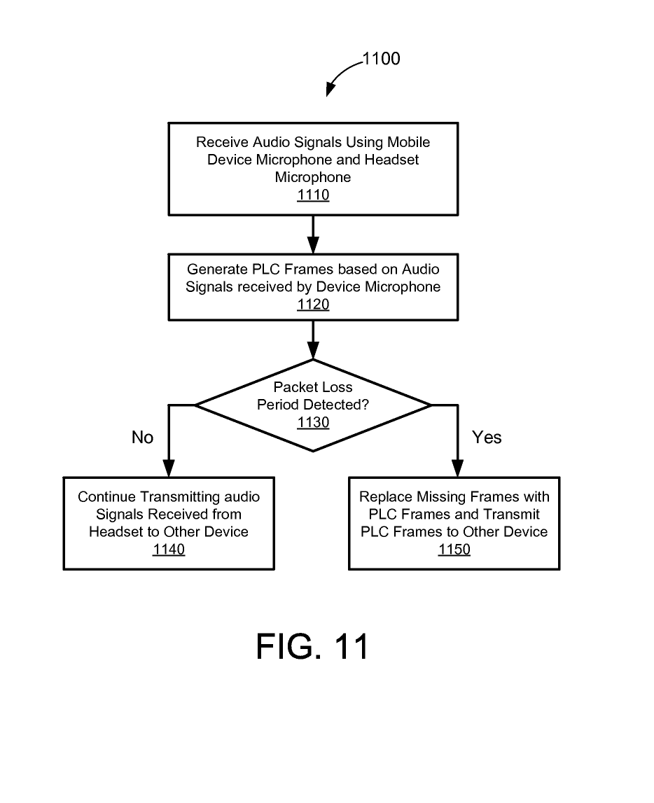

Memory 210 may also include a non-transitory computer-readable storage medium (e.g., one or more nonvolatile memory elements, such as EPROM, EEPROM, Flash memory, a hard drive, and so on) that can store the following software modules:
a data exchange software module 212 to facilitate the creation and/or exchange of various data signals with headset 120, one or more other mobile devices, and/or one or more wireless access points (e.g., as described for operations 310 and 320 of FIG. 3; for operations 610, 640, and 660 of FIG. 6; for operations 710 and 720 of FIG. 7; for operation 910 of FIG. 9; and/or for operations 1110, 1140, and 1150 of FIG. 11);
a power reduction software module 213 to selectively deactivate (e.g., disable or turn off) the device speaker 132, the device microphone 134, the headset speaker 122, and/or the headset microphone 124 and to partially or completely terminate the connection between mobile device 200 and headset 120 (e.g., as described for operations 360, 365, and 370 of FIG. 3; for operations 650, 655, and 670 of FIG. 6; and/or for operations 760, 765, and 780 of FIG. 7);
a proximity software module 214 to estimate proximity values or distances between mobile device 200 and headset 120, between user 110 and mobile device 200, and/or between user 110 and headset 120 (e.g., as described for operations 620 and 630 of FIG. 6);
a privacy software module 215 to determine a privacy level associated with audio signals exchanged with user 110 or with the immediate ambience of the user 110 (e.g., as described for operations 730 and 740 of FIG. 7);
a noise cancellation software module 216 to selectively filter unwanted noise or interference components associated with audio signals received from user 110 (e.g., as described for operations 920, 930, and 940 of FIG. 9); and
a Packet Loss Concealment (PLC) frame software module 217 to facilitate the creation and/or transmission of PLC frames to another mobile device during silent periods detected in audio signals received from user 110 or in the event of packet loss as detected by mobile device 200 (e.g., as described for operations 1120 and 1130 of FIG. 11).
Each software module includes instructions that, when executed by processor 136, cause mobile device 200 to perform the corresponding functions. The non-transitory computer-readable storage medium of memory 210 thus includes instructions for performing all or a portion of the operations 300, 600, 700, 900, and 1100 of FIGS. 3, 6, 7, 9, and 11, respectively.

Processor 136, which is coupled to speaker 132, microphone 134, transceiver 138, and memory 210, can be any suitable processor capable of executing scripts or instructions of one or more software programs stored in mobile device 200 (e.g., within memory 210). For example, processor 136 may execute power reduction software module 213 to process audio signals received from user 110 via device microphone 134 and/or headset microphone 124 to selectively disable one or more components of mobile device 200 and/or headset 120.

More specifically, power reduction software module 213 may analyze audio signals 135 received from the device microphone 134 to determine whether to “deactivate” the headset microphone 124 and/or the headset speaker 122 based upon a quality level of the received audio signals 135. For example, upon establishing a connection with mobile device 200, the headset 120 may initially operate in a full-duplex communication mode with mobile device 200. In this mode, mobile device 200 may receive audio signals 135 from user 110 via its built-in microphone 134 while also receiving audio signals 125 from user 110 via headset 120. Subsequently, power reduction software module 213 may deactivate the headset microphone 124 and/or the headset speaker 122 by (i) terminating the wireless link with headset 120, (ii) sending one or more control signals (CTRL) instructing headset 120 to disable its microphone 124 and/or speaker 122 or to power down, or (iii) stop transmitting signals to headset 120, which in turn may be interpreted by headset 120 to disable its components and/or to power down.

For some embodiments, power reduction software module 213 may determine whether audio signals 135 received from user 110 via device microphone 134 are of an “acceptable” quality that allows for a de-activation of headset microphone 124 and/or headset speaker 122, or that alternatively allows for a power-down of headset 120. For example, power reduction software module 213 may compare audio signal 135 with a quality threshold value (Q_{T}) to determine whether the quality of audio signal 135 is acceptable (e.g., such that the user's voice is perceptible). If the quality of audio signal 135 is acceptable, then power reduction software module 213 may determine that the audio signal 125 (e.g., received by headset microphone 124 and transmitted to mobile device 200 as signal A_IN) is unnecessary and, in response thereto, deactivate or disable headset microphone 124 and/or power-down headset 120. In this manner, power consumption may be reduced in headset 120. For some embodiments, power reduction software module 213 may terminate reception of A_IN signals from headset 120 while continuing to transmit A_OUT signals to headset 120 (e.g., thereby operating the link between mobile device 130 and headset 120 in a half-duplex or simplex mode).

For other embodiments, power reduction software module 213 and/or privacy software module 215 may determine whether the ambience of user 110 is sufficiently private so that incoming audio signals received by mobile device 200 from another mobile device (via the cellular network) can be output via device speaker 132 instead of transmitted to headset 120 as A_OUT and output by headset speaker 122. If the incoming audio signals can be output by device speaker 132, then headset speaker 122 may be de-activated.

FIG. 3 is an illustrative flow chart depicting an exemplary operation 300 in accordance with some embodiments. Referring also to FIG. 1, a connection is first established between headset 120 and mobile device 130 (310). Upon establishing a connection, the headset 120 and mobile device 130 may initially be configured for full-duplex communications, as described above.

Then, mobile device 130 receives audio input signal 135 via its microphone 134 (320). Thus, device microphone 134 may remain active even after mobile device 130 establishes a connection with headset 120. For some embodiments, mobile device 130 also receives audio signal A_IN from headset 120, wherein audio signal 125 is forwarded from headset 120 to mobile device 130 as the audio signal A_IN.

Next, the power reduction software module 213 determines an audio quality (Q_{A}) of the audio signal 135 received by device microphone 134 (330), and compares the audio quality Q_{A} with a quality threshold value Q_{T} (340). For example, the audio quality Q_{A} may indicate an amplitude or overall “loudness” of the audio signal 135, wherein louder audio signals correlate with higher Q_{A} values. In some environments, the audio signal 135 may satisfy the quality threshold Q_{T} but contain mostly ambient or background noise. Thus, for some embodiments, a more accurate audio quality Q_{A} may be determined by comparing the audio signal 135 detected by the device microphone 134 with the audio signal 125 detected by the headset microphone 124 (and transmitted to mobile device 130 as audio signals A_IN).

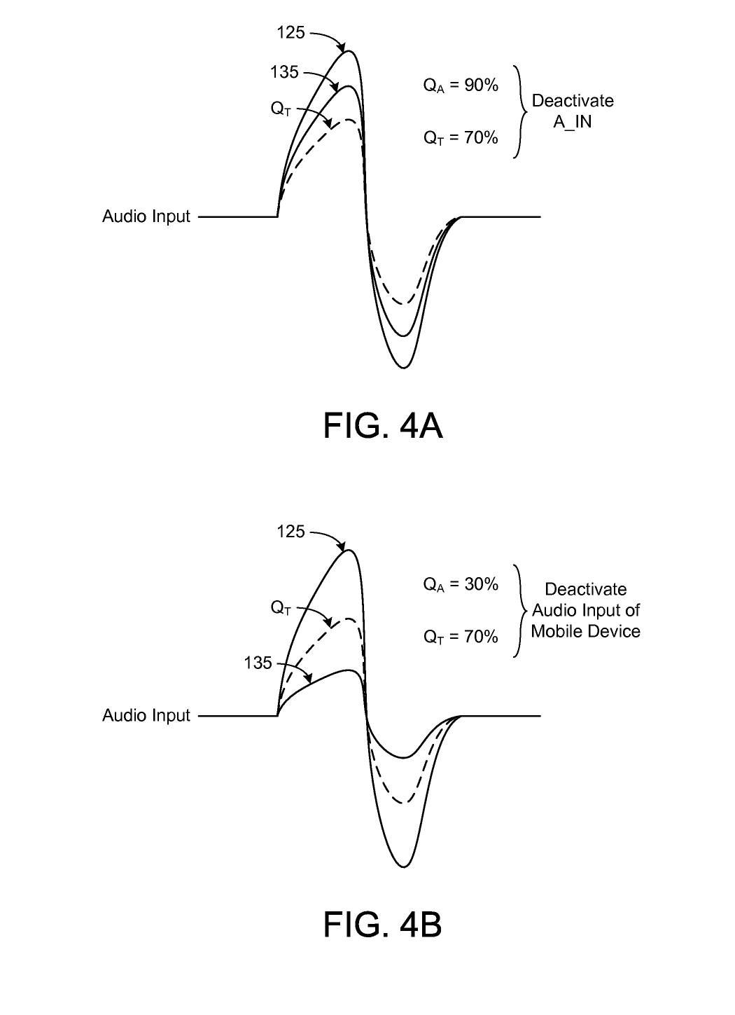

For some embodiments, power reduction software module 213 may initially assume that the audio signal 125 detected by headset microphone 124 is of a higher quality than the audio signal 135 detected by device microphone 134 (e.g., because headset 120 is typically closer to the user's face than is mobile device 130). For such embodiments, power reduction software module 213 may determine the quality Q_{A} of audio signal 135 based upon its similarity with the audio signal A_IN transmitted from headset 120. For one example, FIG. 4A depicts audio signal 135 as being 90% similar to audio signal 125, and depicts the quality threshold value Q_{T} set at approximately 70% percent similarity. For another example, FIG. 4B depicts audio signal 135 as being 30% similar to audio signal 125, which is well below the 70% quality threshold value Q_{T}. For such embodiments, power reduction software module 213 may compare audio signal 125 and audio signal 135 to determine a degree of similarity, which in turn may be used to determine the audio quality of audio signal 135 received by device microphone 134.

Referring again to FIG. 3, if power reduction software module 213 determines that the audio quality Q_{A} is greater than the quality threshold value Q_{T} (e.g., as depicted in FIG. 4A), then power reduction software module 213 may select the audio signal 135 received by device microphone 134 to transmit to another mobile device (e.g., via the cellular network) (350). Thereafter, power reduction software module 213 may deactivate the headset microphone 124, change an existing full-duplex communication link to a half-duplex communication link, and/or power down headset 120 to reduce power consumption in headset 120 (360). Also, for some embodiments, power reduction software module 213 may partially or completely terminate the wireless connection between mobile device 130 and headset 120 (365). For one example, the reception link from headset 120 may be terminated while continuing the transmission link to headset 120, thereby changing the wireless connection from a full-duplex connection to a half-duplex connection. For another example, the headset 120 may be powered down.

Conversely, if power reduction software module 213 determines that the audio quality Q_{A} is below the quality threshold value Q_{T} (e.g., as depicted in FIG. 4B), then power reduction software module 213 may select (or continue using if already selected) the audio signal A_IN (e.g., audio signal 125) received from headset 120 to transmit to the other mobile device (370). Thereafter, power reduction software module 213 may deactivate the device microphone 134 to reduce power consumption in mobile device 130 (380).

The operation 300 may be performed first upon establishing an initial connection between the headset 120 and mobile device 130, and periodically thereafter. For example, because the user 110 is prone to move around, the environment and/or operating conditions of wireless system 100 are likely to change. Accordingly, mobile device 130 may be configured to periodically monitor audio signals 125 received by the headset 120 and/or audio signals 135 received by mobile device 130 to ensure that appropriate power saving techniques are implemented. Note that unless headset 120 is completely disconnected from mobile device 130, subsequent operations 300 may begin at step 320.

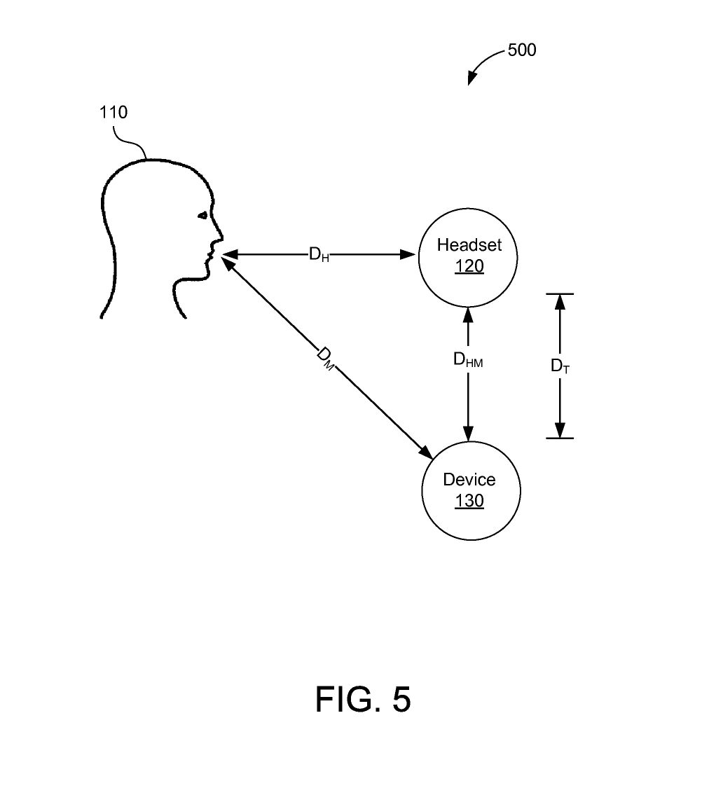

Referring again to FIGS. 1 and 2, power reduction software module 213 may determine whether to deactivate the headset microphone 124 and/or headset speaker 122 based, at least in part, on the proximity of headset 120 to mobile device 130. More specifically, the quality of the audio signal 135 received via the device microphone 134 may depend, at least in part, on the proximity of mobile device 130 to user 110. Referring also to FIG. 5, the distance between mobile device 130 and user 110 is denoted as a distance value D_{M}, the distance between headset 120 and user 110 is denoted as a distance value D_{H}, and the distance between headset 120 and mobile device 130 is denoted as a distance value D_{HM}. Because headset 120 is usually closer to user 110 than is mobile device 130 (e.g., D_{H}<D_{M}), the quality of the audio signal 135 received by device microphone 134 may depend, at least in part, on the proximity of mobile device 130 to headset 120 (e.g., as indicated by the distance value D_{HM}).

For some embodiments, mobile device 130 may determine whether mobile device 130 is within a threshold distance (D_{T}) of headset 120 (e.g., by executing proximity software module 214), and then selectively de-activate one or more components of headset 120. For example, if mobile device 130 is within the threshold distance D_{T} of headset 120 (as depicted in FIG. 5), then mobile device 130 may de-activate the headset microphone 124 to reduce power consumption in headset 120.

For at least one embodiment, mobile device 130 may choose to not execute operation 300 if the distance D_{HM} between mobile device 130 and headset 120 is greater than the threshold distance D_{T}. The mobile device 130 may estimate the distance D_{HM} using, for example, the received signal strength indicator (RSSI) of signals received from headset 120. For at least another embodiment, mobile device 130 may choose to execute a portion of operation 300 (e.g., beginning at step 320) only if it determines that mobile device 130 is sufficiently close to headset 120 (e.g., and thus sufficiently close to user 110) such that the audio signal 135 received by mobile device 130 from user 110 is of acceptable quality. In this manner, the proximity information may be used in conjunction with the audio quality information to determine whether to select audio signal 125 received by headset microphone 124 or audio signal 135 received by device microphone 134.

FIG. 6 is an illustrative flow chart depicting an exemplary proximity determination operation 600 in accordance with some embodiments. First, a connection is established between headset 120 and mobile device 130 (610). Upon establishing a connection, headset 120 and mobile device 130 may initially be configured for full-duplex communications, as described above. For some embodiments, the device speaker 132 and the device microphone 134 may be de-activated upon establishing the connection between headset 120 and mobile device 130.

The mobile device 130 estimates the proximity of headset 120 to mobile device 130 (e.g., as indicated by the distance value D_{HM}), and then compares the proximity (or distance value D_{HM}) with the threshold distance value D_{T} (620). The distance between headset 120 and mobile device 130 may be determined in any suitable manner. For some embodiments, the distance D_{HM} may be determined using suitable ranging techniques such as, for example, received signal strength indicator (RSSI) ranging techniques and/or round trip time (RTT) ranging techniques. For some embodiments, the audio quality Q_{A} of audio signals received by device microphone 134 may be derived in response to the proximity of headset 120 to mobile device 130 (e.g., the distance between headset 120 to mobile device 130) (625).

If mobile device 130 is within the threshold distance D_{T} of headset 120, as tested at 630, then mobile device 130 may enable (e.g., re-activate) its microphone 134 so that audio signals 135 may be received directly from user 110 (640). Further, to reduce power consumption in headset 120 (and/or to eliminate the reception of redundant audio signals from user 110), mobile device 130 may also deactivate the headset microphone 124 (and also headset speaker 122), and/or may partially or completely terminate the communication link between headset 120 and mobile device 130 (650). Also, for some embodiments, power reduction software module 213 may partially or completely terminate the wireless connection between mobile device 130 and headset 120 (655). For one example, the reception link from headset 120 may be terminated while continuing the transmission link to headset 120, thereby changing the wireless connection from a full-duplex connection to a half-duplex connection. For another example, the headset 120 may be powered down.

Thereafter, mobile device 130 may transmit the audio signals 135 detected by device microphone 134 to another device (e.g., via the cellular network).

Conversely, if mobile device 130 is beyond the threshold distance value D_{T} of headset 120, as tested at 630, then mobile device 130 may maintain headset microphone 124 in its enabled state and therefore receive audio signals 125 detected by headset microphone 124 and transmitted to mobile device 130 from headset 120 (i.e., as audio signals A_IN) (660). For example, the mobile device 130 may receive the A_IN signals from headset 120 without activating (or reactivating) the device microphone 134. Thereafter, mobile device 130 may transmit the audio signals 125 detected by headset microphone 124 and received by mobile device 130 as A_IN to another device (e.g., via the cellular network). For some embodiments, mobile device 130 may also deactivate its own microphone 134 (670).

The operation 600 may be performed first upon establishing an initial connection between the headset 120 and mobile device 130, and periodically thereafter. For example, because user 110 is prone to move around, the environment and/or operating conditions of wireless system 100 are likely to change. Accordingly, mobile device 130 may be configured to periodically monitor the distance between mobile device 130 and headset 120 to ensure that appropriate power saving techniques are implemented. Note that unless headset 120 is completely disconnected from mobile device 130, subsequent operations 600 may begin at step 620.

As mentioned above, the proximity information determined by operation 600 may be used in conjunction with the audio quality information determined by operation 300 of FIG. 3 to determine whether to select audio signal 125 received by headset microphone 124 or audio signal 135 received by device microphone 134. For at least one embodiment, an outcome of operation 600 of FIG. 6 may be used as a criterion to determine whether to initiate operation 300 of FIG. 3. For example, if the outcome of operation 600 indicates that mobile device 130 is greater than the threshold distance D_{T} from headset 120, then it may not be necessary to perform operation 300 of FIG. 3 (e.g., because the audio signal 125 detected by headset microphone 124 is to be selected rather than the audio signal 135 detected by device microphone 134).

For some embodiments, mobile device 130 may determine whether user 110 and/or mobile device 130 are in a sufficiently “private” environment so that audio signals can be output to user 110 from the device speaker 132 (e.g., rather than from headset speaker 122). The privacy determination may be made, for example, by executing privacy software module 215 of FIG. 2. For example, if mobile device 130 detects a high level of background noise in the audio signal A_IN received from headset 120 (e.g., if the volume of signal A_IN does not drop below a privacy threshold value P_{T}, or if the volume of signal A_IN does not stay below the privacy threshold value P_{T} for a given duration), then user 110 may not be able to hear audio signals output from the device speaker 132. In this case, mobile device 130 may transmit audio signals A_OUT to headset 120, which in turn outputs the audio signals to user 110 via headset speaker 122. Conversely, if the background noise level is below the privacy threshold value P_{T}, then user 110 may be able to hear audio signals output from the device speaker 132. In this case, use of headset speaker 122 may be redundant, and therefore headset speaker 122 may be deactivated, headset 120 may be powered down, and/or the wireless link between headset 120 and mobile device 130 may be partially or completely terminated to reduce power consumption.

Mobile device 130 may also execute privacy software module 215 to detect the presence of multiple human voices in the audio signal A_IN received from headset 120. For example, the presence of other human voices may indicate that persons other than user 110 are able to hear audio signals output by device speaker 132. Accordingly, mobile device 130 may deactivate its speaker 132 in favor of headset speaker 122 to ensure and/or maintain a desired level of privacy for communications intended for user 110. In addition, upon detecting a low privacy level, mobile device 130 may also prevent audio signals from being transmitted or otherwise routed to devices other than headset 120 (e.g., an in-vehicle telephone communication system). For some embodiments, the desired privacy level may be dynamically determined (e.g., by user 110 in response to user input and/or by mobile device 130 in response to various environmental factors). For such embodiments, the desired privacy level may be stored in suitable memory (e.g., memory 210 of mobile device 200 of FIG. 2) as one or more privacy threshold values (P_{T}).

For other embodiments, a more accurate estimate of the background noise (which may contain human voices other than that of the user) may be determined using the two available representations (e.g., superimpositions) of the “User Voice+Background Noise” as obtained from headset microphone 124 and from mobile device microphone 134, respectively. The mobile device 130 may analyze this more accurate estimate of background noise to determine whether voices other than that of user 110 are present in the background noise. Thereafter, the privacy level may be determined in response to this qualitative assessment of the background noise.

Note that mobile device 130 may terminate transmission of audio signals A_OUT from itself while continuing to receive audio signals A_IN received from headset 120 in response to audio signals 125 detected by the headset microphone 124, or may terminate the connection with headset 120. Thus, for some embodiments, mobile device 130 may terminate only the headset 120 to mobile device 130 link while keeping the mobile device 130 to headset 120 link active, or alternatively may terminate both links to completely disconnect headset 120, if mobile device 130 determines that (i) the audio quality of signals 135 received by device microphone 134 is greater than the quality threshold level Q_{T} and (ii) the ambience of user 110 is sufficiently private so that user 110 is able to use the device speaker 132 instead of the headset speaker 122.

FIG. 7 is an illustrative flow chart depicting an exemplary privacy determination operation 700 in accordance with some embodiments. First, a connection is established between headset 120 and mobile device 130 (710). Upon establishing the connection, the headset 120 and the mobile device 130 may initially be configured for full-duplex communications, as described above.

Headset 120 receives audio signal 125 from user 110, and transmits audio signal 125 as audio signal A_IN to mobile device 130. Mobile device 130 receives audio input signal A_IN from headset 120 (720). For some embodiments, the device speaker 132 and device microphone 134 may be deactivated upon establishing the connection between headset 120 and mobile device 130. For other embodiments, mobile device 130 may also receive audio signals 135 from user 110 via its own microphone 134.

Mobile device 130 determines a privacy level (P_{L}) based on the received audio signal A_IN (730), and then compares the privacy level P_{L} with a privacy threshold value P_{T} (740). For some embodiments, privacy software module 215 (see also FIG. 2) may detect and analyze the volume and/or frequency of background noise components in the received audio signal A_IN signal to determine the privacy level P_{L}. For such embodiments, lower levels of background noise and/or an absence of human voices other than user 110 (e.g., less than a threshold noise value) may indicate higher privacy levels, and higher levels of background noise and/or a presence of human voices other than user 110 (e.g., greater than the threshold noise value) may indicate lower privacy levels. Thus, for the present embodiments, privacy software module 215 may determine the privacy level of user 110 by analyzing various information such as, for example, audio signals received by different microphones (e.g., microphones 124 and 134) and/or messages received from other devices in the vicinity of user 110 (e.g., an in-car infotainment system).

For another embodiment, privacy software module 215 may compare the audio signal A_IN received from headset 120 with the audio signal 135 received by the device microphone 134 to determine the volume and/or frequency of background noise components in the received audio signal A_IN. For yet another embodiment, privacy software module 215 may determine the privacy level P_{L} by heuristically combining a number of different factors such as, for example, information indicating a number of occupants in a car as obtained from a car's infotainment system or information indicating a number of nearby wireless devices in the vicinity of mobile device 130, and so on.

Referring again to FIG. 7, if privacy software module 215 determines that the privacy level P_{L} is greater than the threshold value P_{T}, as tested at 740, then mobile device 130 outputs audio signals to the device speaker 132 (750), and may also deactivate or disconnect the headset speaker 122 to reduce power consumption and/or eliminate duplicative audio signals provided to the user 110 (760). Also, for some embodiments, power reduction software module 213 may partially or completely terminate the wireless connection between mobile device 130 and headset 120 (765). For one example, the reception link from headset 120 may be terminated while continuing the transmission link to headset 120, thereby changing the wireless connection from a full-duplex connection to a half-duplex connection. For another example, the headset 120 may be powered down.

Conversely, if privacy software module 215 determines that the privacy level P_{L} is not greater than the threshold value P_{T}, as tested at 740, then mobile device 130 outputs audio signals to the headset speaker 122 (770), and may also deactivate the device speaker 132 to reduce power consumption and/or eliminate duplicative audio signal provided to the user 110 (780). For at least one embodiment, mobile device 130 may also prevent audio signals intended for user 110 from being transmitted to other external audio systems (e.g., an in-vehicle audio system) to maintain privacy of the user's conversation (790).

For example, a user who is actively participating in a conversation using headset 120 may be approaching his car or other vehicle that may contain other persons. Conventional mobile devices typically employ a hand-off procedure that allows an in-car infotainment system to take over functions of headset 120 when the user approaches the car (e.g., to reduce power consumption of headset 120). However, if the car is already occupied by other passengers when the user approaches, then an automatic hand-off procedure may not be desirable because the conversation will be audible to everyone in the car (or other persons close enough to hear sounds output by the in-car infotainment system). Thus, in accordance with the present embodiments, mobile device 130 may determine the user's privacy level and, in response thereto, selectively prevent a hand-off from headset 120 to the in-car infotainment system. In this manner, if the user's car is occupied by other people as the user approaches, mobile device 130 may decide to continue using headset 120 rather than transferring audio functions to the in-car infotainment system.

The exemplary operation 700 of FIG. 7 may be performed upon establishing an initial connection between headset 120 and mobile device 130, and periodically thereafter. Note that unless headset 120 is completely disconnected from mobile device 130, subsequent operations 700 may begin at step 720.

By selectively deactivating unnecessary (e.g., redundant or duplicative) microphones 124 and 134 and speakers 122 and 132 in the wireless headset 120 and mobile device 130, respectively, the present embodiments may not only reduce power consumption in wireless headset 120 and/or mobile device 130 but also improve the sound quality of conversations facilitated by wireless headset 120 and mobile device 130. In addition, the present embodiments may also be used to ensure and/or maintain a desired level of privacy for user 110, as described above.

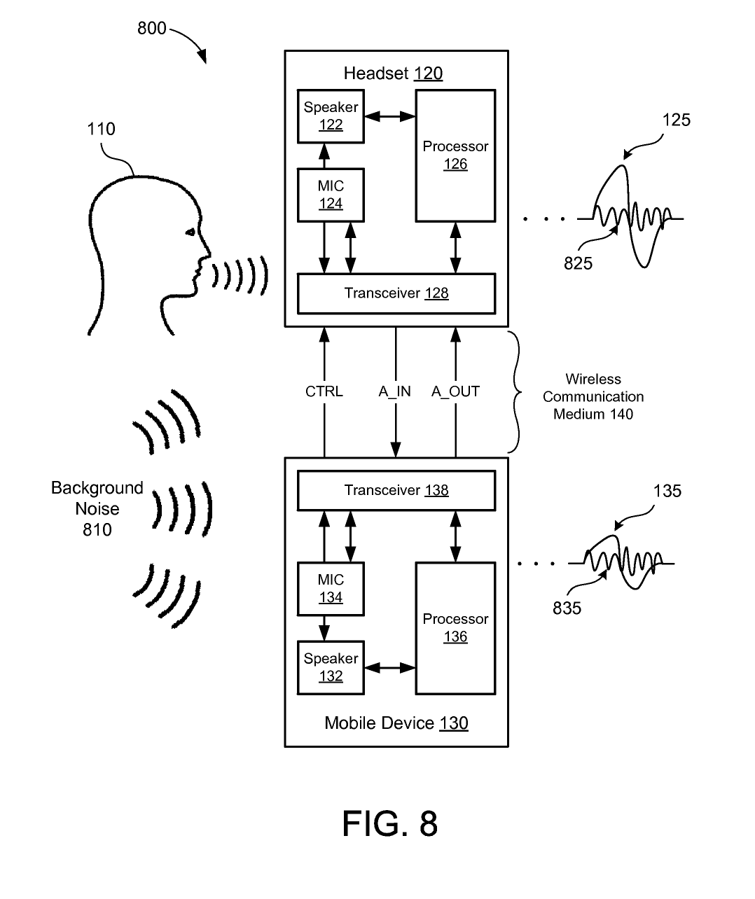

As mentioned above with respect to FIG. 2, for some embodiments, mobile device 130 may execute noise cancellation software module 216 to reduce or eliminate background noise components from audio signals 125 and/or audio signals 135 received from user 110. For example, FIG. 8 depicts an environment 800 having background noise 810. The background noise 810 may appear as background noise components 825 in audio signals 125 detected by headset microphone 124 and/or as background noise components 835 in audio signals 135 detected by device microphone 134. For example, audio signals 125 and 135 may contain intended audio components (e.g., corresponding to the voice of user 110) as well as unwanted noise components 825 and 835 (e.g., wind noise, road noise, or other human voices), respectively. These unwanted noise components 825 and 835 may be distracting and/or undesirably muffle the user's voice. For some embodiments, noise cancellation software module 216 may use audio signals 135 received by the device microphone 134 to enhance audio signals 125 received by the headset microphone 124 (and transmitted to mobile device 130 as input signals A_IN), and/or may use audio signals 125 received by the headset microphone 124 to enhance audio signals 135 received by the device microphone 134 (or vice-versa).

More specifically, for some embodiments, noise cancellation software module 216 may use audio signals 135 received by the device microphone 134 to filter (e.g., remove) ambient or background noise components 825 in the audio signals 125 detected by headset microphone 124. For example, because the distance (D_{H}) between user 110 and headset 120 may be different from the distance (D_{M}) between user 110 and mobile device 130, audio signals 125 detected by headset microphone 124 may be different from audio signals 135 detected by device microphone 134 (and noise components 825 in audio signals 125 may be different than noise components 835 in audio signals 135). Thus, for some embodiments, noise cancellation software module 216 may detect differences between the audio signals 125 and audio signals 135 to filter unwanted noise components 825 and/or unwanted noise components 835.

FIG. 9 is an illustrative flow chart depicting an exemplary noise cancellation operation 900 in accordance with some embodiments. First, mobile device 130 may receive audio signals 135 from device microphone 134 and receive audio signals 125 from headset microphone 124 (910). Noise cancellation software module 216 compares audio signals 125 received by headset microphone 124 with audio signals 135 received by device microphone 134 (920). Next, noise cancellation software module 216 may analyze audio signals 125 received by headset microphone 124 and analyze audio signals 135 received by device microphone 134 to distinguish the intended audio components from the background noise components of the received audio signals (930). For example, by determining which components of the audio signals 125 and 135 are similar and/or determining which components are different (e.g., using audio signal separation techniques applied to audio signals 125 and 135), the noise cancellation software module 216 may distinguish the intended audio components from the unwanted noise components, and thereafter estimate and/or model the background noise. Then, noise cancellation software module 216 may filter background noise components from the received audio signals (940). Noise cancellation software module 216 may employ any suitable noise cancellation and/or filtering technique to filter background noise components from the received audio signals (e.g., in response to differences between audio signals 125 and audio signals 135.

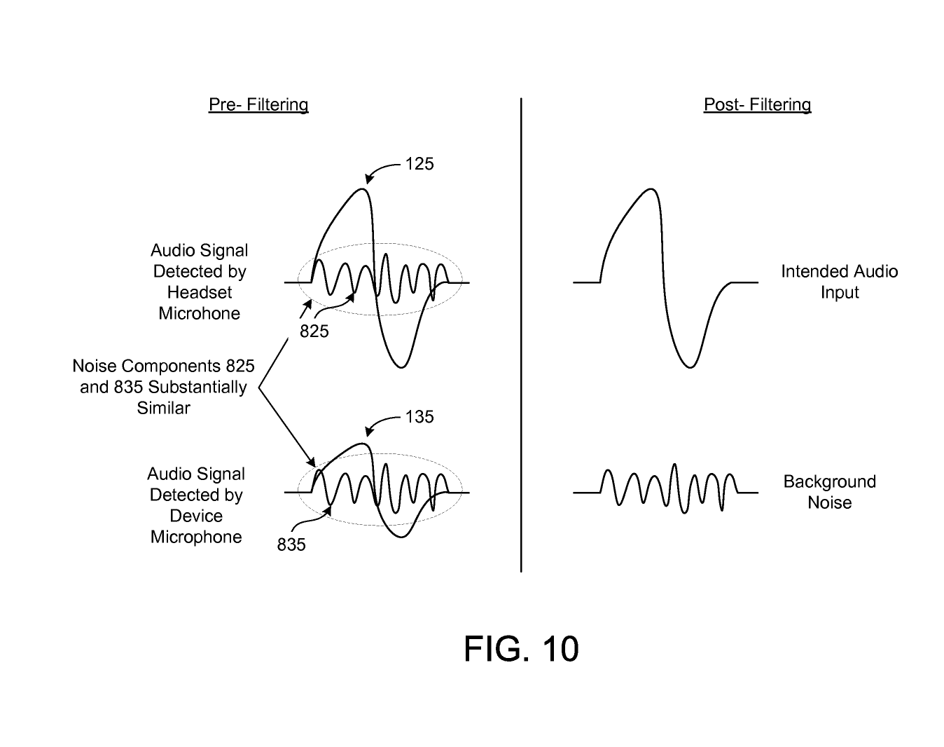

FIG. 10 depicts one embodiment of the exemplary noise cancellation operation 900 of FIG. 9. As shown in FIG. 10, audio signals 125 detected by headset microphone 124 may include unwanted noise components 825, and audio signals 135 detected by device microphone 134 may include unwanted noise components 835. Note that the intended audio components of audio signal 125 are depicted in FIG. 10 as having a greater amplitude (e.g., louder or more audible) than the amplitude of the intended audio components of audio signal 135, while the noise components 825 and 835 of respective audio signals 125 and 135 are substantially similar to each other. The similarities of noise components 825 and 835 may result from background noise emanating from different directions, while the differences in the intended audio components of audio signals 125 and 135 may result from headset 120 being closer to user 110 than is mobile device 130.

More specifically, noise cancellation techniques are typically based upon a determination of background noise, which in turn may be performed using multiple microphones physically spaced apart. Greater distances between the microphones allows suitable signal processing techniques to be more effective in separating and attenuating background noise components. Although conventional noise cancelling wireless headsets may employ multiple microphones to obtain different audio samples, the physical separation of microphones on such headsets is limited by the small form factor of such headsets. Accordingly, the present embodiments may allow for more effective noise cancellation operations than conventional techniques by using both the headset microphone(s) 124 and the mobile device microphone(s) 134 to obtain multiple audio samples of the background noise, wherein the amount of physical separation between the headset microphone(s) 124 and the mobile device microphone(s) 134 may be much greater than the physical dimensions of headset 120. Note that estimation of the background noise may be performed periodically or may be triggered whenever an audio quality level drops below a certain threshold value (e.g., below the quality threshold value Q_{T}).

Thus, for some embodiments, the relative proximity of headset 120 to user 110 (as compared to the proximity of mobile device 130 to user 110) may also be used as an indication of the differences in audio signals 125 detected by headset microphone 124 and audio signals 135 detected by device microphone 134. The effectiveness of the noise cancellation operation 900 of FIG. 9 may thus be dependent upon the distance (D_{HM}) between headset 120 and mobile device 130. For example, increasing the distance (D_{HM}) between headset 120 and mobile device 130 may result in greater differences between audio signals 125 detected by headset microphone 124 and audio signals 135 detected by device microphone 134, which in turn may allow noise cancellation software module 216 to more accurately detect differences between noise components 825 and 835 of audio signals 125 and 135, respectively.

Referring again to FIGS. 1 and 2, for some embodiments, mobile device 130 may use audio signals 135 received by device microphone 134 to generate one or more packet loss concealment (PLC) frames, which in turn may be transmitted to another device (e.g., to another phone) during gaps or silent periods in audio signals A_IN received from headset 120. These gaps or silent intervals may correspond to packet losses detected in the link between headset 120 and mobile device 130. More specifically, during idle periods that headset 120 does not transmit audio signals to mobile device 130, mobile device 130 may transmit one or more PLC frames to the other device (e.g., rather than transmitting no audio signals or silent packets or interpolated packets). In this manner, a user of the other device may hear subtle background noise or static (e.g., the actual background audio) produced by the PLC frames rather than silence during periods that user 110 is not speaking. Allowing the user of the other device to hear subtle background noise rather than silence may be desirable, for example, because the user of the other device may incorrectly interpret silence as termination of the conversation facilitated by mobile device 130. Thus, as used herein, an idle period refers to a period of time during which headset 120 does not transmit audio signals (A_IN) to mobile device 130, a silent period refers to a period of time during which user 110 is not speaking (e.g., and does not generate audio signals 125 or 135), and a packet loss period refers to a period of time during which mobile device 130 detects packet loss resulting from either silent periods or from interference that causes reception errors in mobile device 130. Thus, for some embodiments, the terms “silent period,” “idle period,” and “packet loss period” may refer to the same period of time.

Accordingly, for some embodiments, mobile device 130 may employ packet loss concealment techniques during time intervals in which mobile device 130 either (i) does not receive packets or frames or (ii) receives packets containing errors from headset 120. During such intervals, it may be desirable to transmit local samples of audio signals (e.g., received by mobile device microphone 134) to the other mobile device (via the cellular network) rather than transmitting silent or interpolated packets because the local samples may contain components of the user 110's voice. More specifically, although components of user 110's voice contained in the local samples received by device microphone 134 may not be as strong as components of user 110's voice contained in audio signals 125 received by headset microphone 124, the local samples may provide a better estimate of user 110's voice than audio signals 125 during the packet loss periods. Thus, for some embodiments, the local samples received by device microphone 134 may be used to perform packet loss concealment operations (e.g., especially when synchronous connections with zero or limited retransmissions are used). Further, for some embodiments, upon detecting RF interference resulting in high packet error rates, mobile device 130 may employ packet loss concealment operations described herein to avoid re-transmissions in synchronous connections without adversely affecting audio quality.

FIG. 11 is an illustrative flow chart depicting a packet loss concealment (PLC) operation 1100 in accordance with some embodiments. First, mobile device 130 receives audio input signals 125 and 135 via headset microphone 124 and device microphone 134, respectively (1110). Upon receiving signals 125 transmitted as A_IN signals from headset 120, mobile device 130 may subsequently begin transmitting the A_IN signals, via a cellular network, to another mobile device. More specifically, mobile device 130 may transmit a series of data packets/frames corresponding to the A_IN signals.

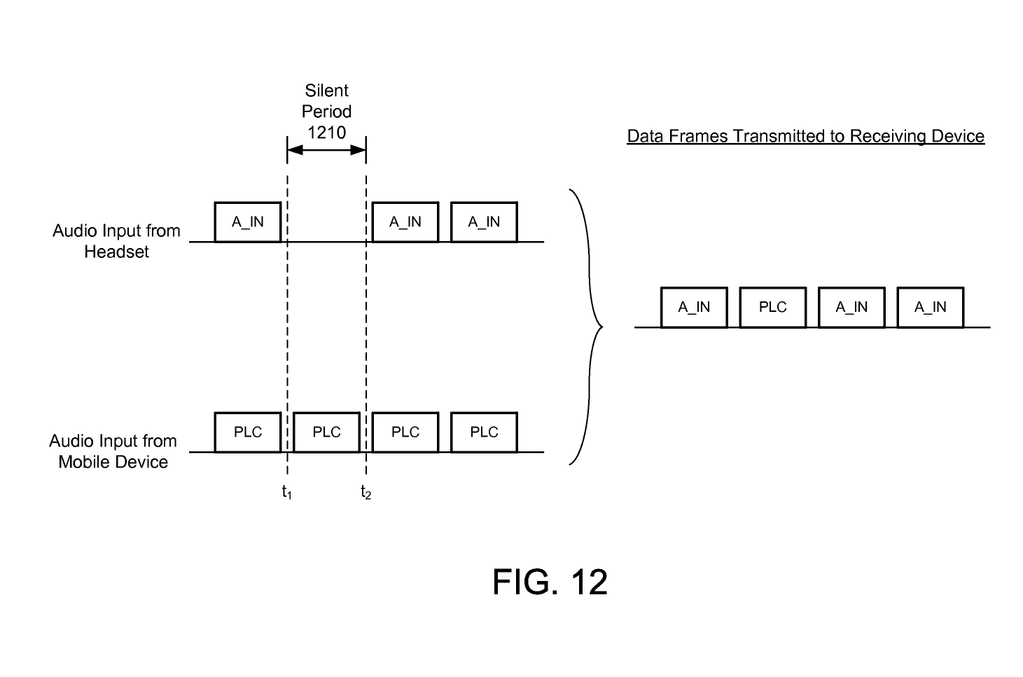

Then, PLC frame software module 217 generates PLC frames based on audio signal 135 received from device microphone 134 (1120). For some embodiments, PLC frame software module 217 generates PLC frames for the entire duration of audio signal 135. For example, referring also to FIG. 12, PLC frame software module 217 may generate PLC frames in parallel with data frames corresponding to the A_IN signals, regardless of whether mobile device 130 actually uses them. Alternatively, PLC frame software module 217 may generate PLC frames only upon detecting (i) silent periods associated with no audio signals received from headset 120 or (ii) actual packet loss resulting from RF interference that causes the packet error rate (PER) to be greater than a packet error rate threshold value. For either scenario, when a packet loss period is initially detected, the mobile device microphone 134 may be turned off and suitable packet loss concealment operations may be employed. Thereafter, if mobile device 130 detects packet error rates greater than the packet error threshold value, mobile device 130 may turn on its built-in microphone 134 and begin generating PLC frames based on audio signals 135 received by device microphone 134. For some embodiments, mobile device 130 may again turn off its built-in microphone 134 when the packet error rate falls below the packet error rate threshold value.

Next, PLC frame software module 217 detects whether there is a packet loss period (1130). As mentioned above, the packet loss period may correspond to actual packet loss on the link between headset 120 and mobile device 130 or to a silent period in user 110's voice. As long as headset 120 remains connected to mobile device 130, mobile device 130 may expect to receive continuous streams of A_IN signals from headset 120. However, as discussed above, headset 120 may not transmit A_IN signals to mobile device 130 during time periods that user 110 is not speaking (e.g., to save power), thereby causing packet loss on the link between headset 120 and mobile device 130. Furthermore, even if headset 120 transmits A_IN signals continuously, various external sources of interference may prevent the A_IN signals from reaching mobile device 130. Thus, as depicted in FIG. 12, mobile device 130 may detect a silent period 1210 (e.g., from time t₁ to t₂) that may indicate a break in the reception of A_IN signals from headset 120. The silent period may correspond to packet loss resulting from a true silent interval and/or may correspond to packet loss resulting from packet reception errors in mobile device 130.

If PLC frame software module 217 does not detect a packet loss period, as tested at 1130, then mobile device 130 may continue transmitting data frames corresponding to the received A_IN signals to the other receiving device (via the cellular network) (1140). For some embodiments, PLC frame software module 217 may continue generating PLC frames in parallel with generating the data frames representing the received A_IN signals.

Conversely, if PLC frame software module 217 detects a packet loss period, as tested at 1130, then the PLC frame software module 217 may replace missing data frames corresponding to the A_IN signal with one or more PLC frames (1150). For example, as depicted in FIG. 12, PLC frame software module 217 may select PLC frames that are generated during silent interval 1210 to be inserted into the series of data packets transmitted to the other receiving device (via the cellular network). This is in contrast to conventional wireless PAN systems in which the mobile device inserts “silent” packets into the silent periods associated with audio signals forwarded from the headset.

In some instances, the PLC frames transmitted during silent interval 1210 may contain primarily background noise. However, because the background noise detected by device microphone 134 may be substantially similar to the background noise detected by headset microphone 124, the PLC frames transmitted to the other receiving device may be incorporated seamlessly with adjacent data frames corresponding to the A_IN signal. In other instances (e.g., where the packet loss results from RF interference and not by an absence of the user's voice), the PLC frames may contain one or more portions of an intended audio input (e.g., the user's voice). Although there may be differences (e.g., in loudness and/or clarity) in the intended audio components of audio signal 135 and audio signal 125, the PLC packets sent to the other receiving device may sound much more “natural” (e.g., than the silent interval) to a user of the other receiving device.

It will be appreciated that all of the embodiments described herein may be implemented within mobile device 130. Accordingly, the power saving techniques, privacy techniques, noise cancellation techniques, and/or packet loss concealment techniques described herein may be performed with existing wireless headsets.

In the foregoing specification, the present embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense. For example, the method steps depicted in the flow charts of FIGS. 3, 6, 7, 9, and 11 may be performed in other suitable orders and/or multiple steps may be combined into a single step.

What is claimed is:

1. A method of operating a mobile device, the method comprising:
establishing a connection with a wireless headset;
receiving, via a microphone of the mobile device, a first audio signal from a user;
determining an audio quality of the first audio signal; and
deactivating a microphone of the wireless headset if the audio quality is greater than a first threshold value.

2. The method of claim 1, further comprising:
deactivating the device microphone if the audio quality is not greater than the first threshold value.

3. The method of claim 1, wherein determining the audio quality comprises:
receiving, via the headset microphone, a second audio signal from the user;
comparing the first audio signal and the second audio signal; and
determining a degree of similarity between the first audio signal and the second audio signal in response to the comparing.

4. The method of claim 3, wherein the headset microphone is deactivated if the degree of similarity is greater than a second threshold value.

5. The method of claim 1, wherein determining the audio quality comprises:
estimating a distance between the wireless headset and the mobile device; and
deriving an estimate of the audio quality in response to the distance.

6. The method of claim 1, further comprising:
determining a privacy level of the user by analyzing the first audio signal; and
deactivating the headset microphone if the privacy level is greater than a second threshold value.

7. The method of claim 6, wherein the privacy level indicates an amount of background noise detected in the first audio signal.

8. The method of claim 6, wherein determining the privacy level further comprises:
receiving, via the headset microphone, a second audio signal from the user;
comparing the first audio signal and the second audio signal; and
determining a degree of similarity between the first audio signal and the second audio signal in response to the comparing.

9. The method of claim 6, further comprising:
preventing a hand-off of audio signals to an external audio system if the privacy level is not greater than the second threshold value.

10. The method of claim 1, further comprising:
receiving, via the headset microphone, a second audio signal from the user;
analyzing the first audio signal and the second audio signal; and
filtering a background noise component from the second audio signal in response to the analyzing.

11. The method of claim 1, further comprising:
receiving, via the headset microphone, a second audio signal from the user;
detecting a packet loss period in a link transmitting the second audio signal; and
transmitting one or more packet loss concealment (PLC) frames to another user during the packet loss period.

12. The method of claim 11, further comprising:
generating the one or more PLC frames in response to the first audio signal received by the device microphone.

13. The method of claim 11, wherein the transmitting comprises:
inserting the one or more PLC frames into the second audio signal.

14. A computer-readable storage medium containing program instructions that, when executed by a processor of a mobile device, cause the mobile device to:
establish a connection with a wireless headset;
receive, via a microphone of the mobile device, a first audio signal from a user;
determine an audio quality of the first audio signal; and
deactivate a microphone of the wireless headset if the audio quality is greater than a first threshold value.

15. The computer-readable storage medium of claim 14, wherein execution of the program instructions further causes the mobile device to:
deactivate the device microphone if the audio quality is not greater than the first threshold value.

16. The computer-readable storage medium of claim 14, wherein execution of the program instructions to determine the audio quality causes the mobile device to:
receive, via the headset microphone, a second audio signal from the user;
compare the first audio signal and the second audio signal; and
determine a degree of similarity between the first audio signal and the second audio signal in response to the compare.

17. The computer-readable storage medium of claim 16, wherein the processor is to deactivate the headset microphone if the degree of similarity is greater than a second threshold value.

18. The computer-readable storage medium of claim 14, wherein execution of the program instructions to determine the audio quality causes the mobile device to:
estimate a distance between the wireless headset and the mobile device; and
derive an estimate of the audio quality in response to the distance.

19. The computer-readable storage medium of claim 14, wherein execution of the program instructions further causes the mobile device to:
determine a privacy level of the user by analyzing the first audio signal; and
deactivate the headset microphone if the privacy level is greater than a second threshold value.

20. The computer-readable storage medium of claim 19, wherein the privacy level indicates an amount of background noise detected in the first audio signal.

21. The computer-readable storage medium of claim 19, wherein execution of the program instructions to determine the audio quality causes the mobile device to:
receive, via the headset microphone, a second audio signal from the user;
compare the first audio signal and the second audio signal; and
determine a degree of similarity between the first audio signal and the second audio signal in response to the compare.

22. The computer-readable storage medium of claim 19, wherein execution of the program instructions further causes the mobile device to:
prevent a hand-off of audio signals to an external audio system if the privacy level is not greater than the second threshold value.

23. The computer-readable storage medium of claim 14, wherein execution of the program instructions further causes the mobile device to:
receive, via the headset microphone, a second audio signal from the user;
analyze the first audio signal and the second audio signal; and
filter a background noise component from the second audio signal in response to the analyzing.

24. The computer-readable storage medium of claim 14, wherein execution of the program instructions further causes the mobile device to:
receive, via the headset microphone, a second audio signal from the user;
detect a packet loss period in the second audio signal; and
transmit one or more packet loss concealment (PLC) frames to another user during the packet loss period.

25. The computer-readable storage medium of claim 24, wherein execution of the program instructions further causes the mobile device to:
generate the one or more PLC frames in response to the first audio signal received by the device microphone.

26. A mobile device, comprising:
a microphone to receive a first audio signal from a user; and
a processor to:
establish a connection with a wireless headset;
determine an audio quality of the first audio signal; and
deactivate a microphone of the wireless headset if the audio quality is greater than a first threshold value.

27. The mobile device of claim 26, wherein the processor is to further:
deactivate the device microphone if the audio quality is not greater than the first threshold value.

28. The mobile device of claim 26, wherein the processor is to determine the audio quality by:
receiving, via the headset microphone, a second audio signal from the user;
comparing the first audio signal and the second audio signal; and
determining a degree of similarity between the first audio signal and the second audio signal.

29. The mobile device of claim 28, wherein the headset microphone is deactivated if the degree of similarity is greater than a second threshold value.

30. The mobile device of claim 26, wherein the processor is to further:
determine a privacy level of the user by analyzing the first audio signal; and
deactivate the headset microphone if the privacy level is greater than a second threshold value.

31. The mobile device of claim 30, wherein the privacy level indicates an amount of background noise detected in the first audio signal.

32. The mobile device of claim 30, wherein the processor is to further:
prevent a hand-off of audio signals to an external audio system if the privacy level is not greater than the second threshold value.

33. The mobile device of claim 26, wherein the processor is to further:
receive, via the headset microphone, a second audio signal from the user;
analyze the first audio signal and the second audio signal; and
filter a background noise component from the first audio signal in response to the analyzing.

34. The mobile device of claim 26, wherein the processor is to further:
receive, via the headset microphone, a second audio signal from the user;
detect a packet loss period in the second audio signal; and
transmit one or more packet loss concealment (PLC) frames to another user during the packet loss period.

35. A mobile device, comprising:
means for establishing a connection with a wireless headset;
means for receiving, via a microphone of the mobile device, a first audio signal from a user;
means for determining an audio quality of the first audio signal; and
means for deactivating a microphone of the wireless headset if the audio quality is greater than a first threshold value.

36. The mobile device of claim 35, further comprising:
means for deactivating the device microphone if the audio quality is not greater than the first threshold value.

37. The mobile device of claim 35, further comprising:
means for determining a privacy level of the user by analyzing the first audio signal; and
means for deactivating the headset microphone if the privacy level is greater than a second threshold value.

38. The mobile device of claim 37, further comprising:
means for preventing a hand-off of audio signals to an external audio system if the privacy level is not greater than the second threshold value.

39. The mobile device of claim 35, further comprising:
means for receiving, via the headset microphone, a second audio signal from the user;
means for analyzing the first audio signal and the second audio signal; and
means for filtering a background noise component from the first audio signal in response to the analyzing.

40. The mobile device of claim 35, further comprising:
means for receiving, via the headset microphone, a second audio signal from the user;
means for detecting a packet loss period in the second audio signal; and
means for transmitting one or more packet loss concealment (PLC) frames to another user during the packet loss period.
